(19) United States
(12) Patent Application Publication
(10) Pub. No.: US 2013/0233828 A1
(43) Pub. Date: Sep. 12, 2013

(54) PLASMA PROCESSING APPARATUS AND PLASMA PROCESSING METHOD

(71) Applicants: Masashi Matsumori, Osaka (JP); Shigeki Nakatsuka, Kyoto (JP); Teppei Kojio, Yamanashi (JP)

(72) Inventors: Masashi Matsumori, Osaka (JP); Shigeki Nakatsuka, Kyoto (JP); Teppei Kojio, Yamanashi (JP)

(21) Appl. No.: 13/884,143

(22) PCT Filed: Nov. 8, 2011
(86) PCT No.: PCT/JP2011/006240

§ 371 Date: May 8, 2013

(30) Foreign Application Priority Data
Nov. 10, 2010 (JP) 2010-251959

(51) Int. Cl. H05H 1/46

(52) U.S. Cl. CPC H05H 1/46
USPC 216/67; 156/345.48; 156/345.3

(57) ABSTRACT

An atmospheric plasma irradiation unit has a discharge tube for ejecting a primary plasma formed of an inductively coupled plasma of an inert gas and a mixer for generating a secondary plasma formed of a mixed gas plasmanized by collisions of the primary plasma with a mixed gas region of a second inert gas and a reactive gas. The discharge tube and the mixer are included in a plasma head. A moving unit moves the plasma head so that an irradiation area of the secondary plasma to an object is moved on a circular or other-shaped locus.

### TECHNICAL FIELD

The present invention relates to a plasma processing apparatus and a plasma processing method.

### BACKGROUND ART

Copper has such features as low price, high thermal conductivity, high electrical conductivity, high mechanical strength and easiness of machining and joint and therefore is widely used as a material for electrodes and the like. However, copper is easily oxidized in the air to form copper oxide (I) (Cu₂O) even at low temperatures and to form copper oxide (II) (CuO) at high temperatures during manufacturing process. Those oxides cause such problems as shortage of solder wettability, cracks and shortage of bonding strength at interconnection wires as well as peeling of molding resin and intrusion of moisture in lead frames.

Among known methods for removing a copper oxide film includes a method of physically scraping off (polishing) the film by a Leutor and a method of applying oxidation-reduction over a wide range by vacuum plasma (e.g., JP 2001-262378 A). However, the physical polishing method takes long time, is more likely to vary in quality, and has a possibility of re-oxidation. Further, although effective for wide-range regions of oxide removal, the vacuum plasma reduction requires larger-scale equipment and therefore is not suitable for efficient fulfillment of partial reduction and removal of the copper oxide film (for high-speed fulfillment of selective reduction and removal of the copper oxide film).

JP 2008-4722 A and JP 4409439 B include disclosures relating to partial oxidation-reduction by atmospheric plasma. However, these documents does not teach specific method for efficiently achieving the partial oxidation-reduction of copper oxide films.

### SUMMARY OF INVENTION

### Problem to be Solved by the Invention

An object of the present invention is to efficiently achieve partial oxidation-reduction of copper oxide films.

### Means for Solving the Problem

In order to achieve the object, the invention has the following arrangements.

A first aspect of the present invention provides a plasma processing apparatus comprising, a holding section for holding an object subject to removal of a copper oxide film, an atmospheric plasma irradiation unit including, an inductively coupled plasma generation section for ejecting a primary plasma formed of an inductively coupled plasma of a first inert gas, and a plasma development section for generating a secondary plasma formed of a mixed gas plasmanized by collisions of the primary plasma with a mixed gas region of a second inert gas and a reactive gas, the atmospheric plasma irradiation unit irradiating the secondary plasma to the object, and a moving section for relatively moving the holding section and the atmospheric plasma irradiation unit so that an irradiation area of the secondary plasma to the object is moved, wherein the first and second inert gases are Ar gas and the reactive gas is H₂ gas, and wherein an H₂ concentration of the mixed gas including the Ar gas, which is the second inert gas, and the H₂ gas, which is the reactive gas, is not less than 0.5% and not more than 3.0%. More preferably, the H₂ concentration of the mixed gas is 2.5%.

The primary plasma (Ar plasma) from the inductively coupled plasma generation section is introduced to the mixed gas region of the second inert gas and the reactive gas (Ar gas and H₂ gas) in the plasma development section so that the primary plasma excites the second inert gas (Ar gas) in the mixed gas to form an expanded secondary plasma (Ar plasma). Then, the resulting secondary plasma (Ar plasma) activates an element (hydrogen) constituting the reactive gas. The activated hydrogen causes chemical reaction at the surface of the object held on the holding section to thereby reduce and remove the copper oxide film. Since the irradiation area of the secondary plasma in the object is moved by relative movement of the holding section and the atmospheric plasma irradiation unit by the moving section, temperature increases of the object due to heat of reaction of the atmospheric plasma and its resultant oxidation reaction (re-oxidation) of copper are suppressed, so that processing uniformity can be ensured even with a larger-area region targeted for reduction and removal of copper oxide films. Consequently, partial reduction and removal of copper oxide films can be efficiently achieved.

Preferably, the moving section relatively moves the holding section and the atmospheric plasma irradiation unit so that the irradiation area is moved at a constant speed.

Preferably, the moving section relatively moves the holding section and the atmospheric plasma irradiation unit so that the irradiation area is moved in a circular or circular-arc shape.

Preferably, the moving section relatively moves the holding section and the atmospheric plasma irradiation unit so that there arises an overlap between the moved irradiation areas.

Preferably, the holding section includes a heating unit for heating the object.

With this arrangement, the increased temperature of the copper oxide film due to the heating of the object by the heating unit accelerates chemical reaction by the hydrogen, so that the copper oxide film can be reduced and removed more efficiently.

A second aspect of the present invention provides a plasma processing method comprising, generating a primary plasma formed of an inductively coupled plasma of a first inert gas followed by generation of a secondary plasma formed of a plasmanized mixed gas resulting from collision of the primary plasma to the mixed gas of a second inert gas and the reactive gas, and while moving the secondary plasma relative to the irradiation area, irradiating the secondary plasma to a copper oxide film of the surface of the object, wherein the first and second inert gases are Ar gas and the reactive gas is H₂ gas, and wherein an H₂ concentration of the mixed gas including the Ar gas, which is the second inert gas, and the H₂ gas, which is the reactive gas, is not less than 0.5% and not more than 3.0%.

### Effect of the Invention

According to the plasma processing apparatus and the plasma processing method of the invention, a secondary plasma is generated by plasmanization caused by collisions of a primary plasma, which is an inductively coupled plasma of a first inert gas, and a mixed gas of a second inert gas and a reactive gas, and then an irradiation area of the secondary plasma to the object is moved. Therefore, temperature increases of the object due to heat of reaction of the atmospheric plasma and its resultant oxidation reaction (re-oxidation) of copper are suppressed, so that processing uniformity can be ensured even with a larger-area region targeted for reduction and removal of copper oxide films. Consequently, partial reduction and removal of copper oxide films can be achieved efficiently.

### BRIEF DESCRIPTION OF DRAWINGS

FIG. 1 is a schematic view showing a plasma processing apparatus according to an embodiment of the invention;

FIG. 2 is a schematic enlarged view of around a mixer;

FIG. 3 is a schematic view showing an example of a movement locus of an irradiation area of atmospheric plasma in the embodiment;

FIG. 4 is a schematic view showing an example of a movement locus of a processing area involving regions to which plasma is not applied;

FIG. 5 is a graph showing a relationship between heating time and copper oxide film thickness;

FIG. 6 include graphs showing distributions of atomic concentrations (at %) of copper, oxygen and carbon in depth directions of an object in (a) an unprocessed portion, (b) a central portion, and (c) a peripheral portion of an irradiation area of atmospheric plasma;

FIG. 7 is a schematic plan view showing concepts of the unprocessed portion, the central portion, and the peripheral portion of an irradiation area of atmospheric plasma in an object in the irradiation area of atmospheric plasma;

FIG. 8 is a graph showing relationships between plasma irradiation time and processing area diameter;

FIG. 9 is a graph showing relationships between processing area diameter and reduction ratio of copper oxide film; and

FIG. 10 is a graph showing a relationship between hydrogen concentration and processing area radius.

### EMBODIMENT FOR CARRYING OUT THE INVENTION

Hereinbelow, an embodiment of the present invention will be described with reference to the accompanying drawings. It is noted that the invention is not limited by this embodiment.

### Embodiment

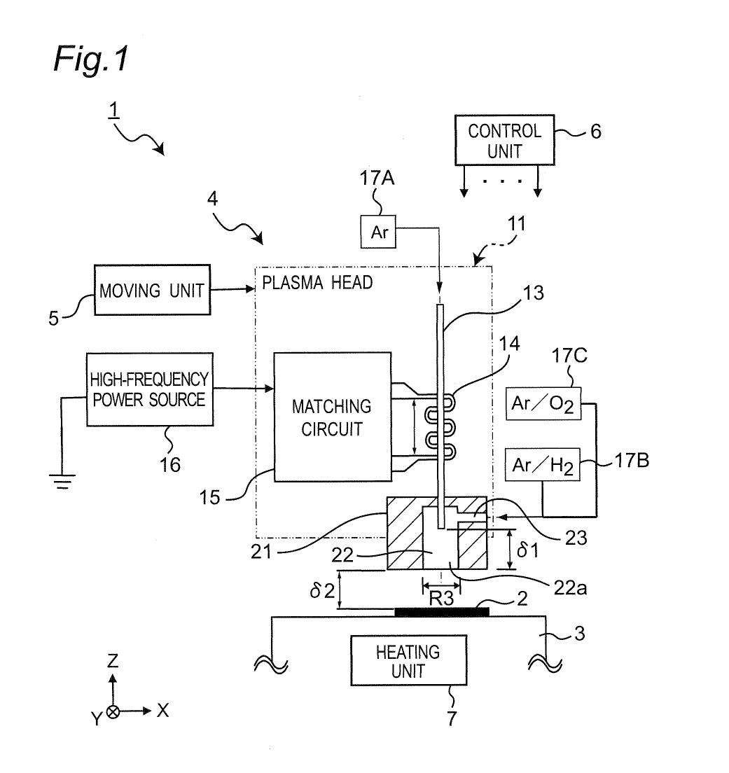

A plasma processing apparatus 1 according to an embodiment of the invention shown in FIG. 1 irradiates a microscopic atmospheric plasma at high speed to reduce and remove copper oxide films from target portions (e.g., electrode portions of copper interconnection wires of a substrate, or copper electrodes (bumps) of electronic components) of copper interconnects of an object 2 (e.g., a substrate board, an electronic component, etc.). That is, the plasma processing apparatus 1 of this embodiment selectively reduces and removes the copper oxide film at high speed with atmospheric microplasma jet.

The plasma processing apparatus 1 includes a stage (holding section) 3, an atmospheric plasma irradiation unit 4, a moving unit 5, and a control unit 6.

The stage 3 removably holds the object 2. The stage 3 also includes a heating unit 7 so as to heat the held object 2 to a specified temperature above room temperature.

The atmospheric plasma irradiation unit 4 includes a cylindrical-shaped discharge tube (inductively coupled plasma generation section) 13. The discharge tube 13 is formed of a dielectric member housed in a movable plasma head 11 and defines a circular-in-section reaction space 12. A wavy-shaped, flat-plate type antenna 14 is provided outside the discharge tube 13. A high-frequency power source 16 is connected to the antenna 14 via a matching circuit 15. A first gas source 17A for supplying the discharge tube 13 with Ar gas, which is an inert gas, is connected to an upper end side of the discharge tube 13.

A mixer (plasma development section) 21 is fitted on a lower end side of the plasma head 11. The mixer 21 has a mixing chamber 22 having an opening (plasma ejection port 22a) formed at a lower end thereof. A lower end of the discharge tube 13 is inserted within the mixing chamber 22 of the mixer 21. Also, one or more gas supply port 23 are provided in a peripheral wall of the mixing chamber 22. The gas supply port 23 is connected to a second gas source 17B and/or a third gas source 17C. As described later, a mixed gas can be supplied into the mixing chamber 22 selectively from either the second gas source 17B or the third gas source 17C. The second gas source 17B supplies a mixed gas of Ar gas as an inert gas and H₂ gas as a reactive gas (Ar/H₂ gas). The third gas source 17C supplies a mixed gas of Ar gas as an inert gas and O₂ gas as a reactive gas (Ar/O₂ gas).

The plasma head 11 can be moved for horizontal movements (movements in X and Y directions in FIG. 1) and up/down movements (movements in Z direction in FIG. 1) by the moving unit 5. By the horizontal movements and up/down movements of the plasma head 11, the plasma ejection port 22a of the atmospheric plasma irradiation unit 4 can be moved horizontally and vertically relative to the object 2.

The control unit 6 controls operations of the plasma processing apparatus 1 as a whole including movements of the plasma head 11 by the moving unit 5 as well as supply or switching of the second gas source 17B and the third gas source 17C.

Then, plasma processing by the plasma processing apparatus 1 of this embodiment will be explained below.

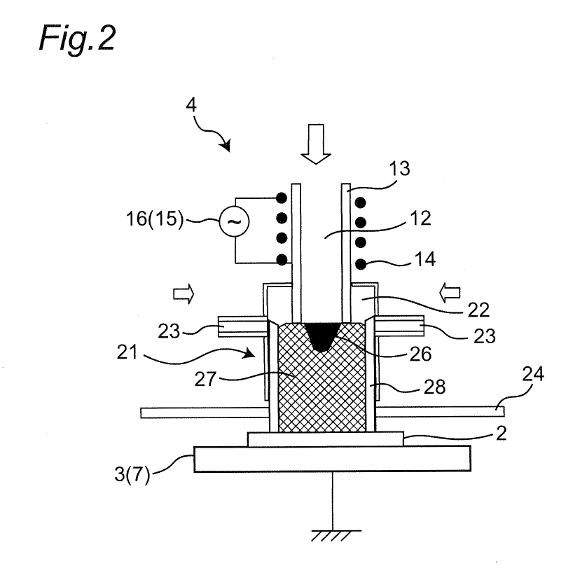

First, an object 2 subject to reduction and removal of copper oxide films is held on the stage 3. Further, the object 2 on the stage 3 is heated by the heating unit 7. For example, the stage 3 is heated to temperatures of 30° C. to 80° C. and maintained at the temperatures. Further, the moving unit 5 moves the plasma head 11 so that the plasma ejection port 22a is positioned above the object 2 with a predetermined distance (gap 62) therebetween. In addition, as shown only in FIG. 2 conceptually, a mask 24 is placed between the atmospheric plasma irradiation unit 4 and the object 2. The mask 24 is formed with openings positioned at portions of the surface of the object 2 subject to reduction and removal of copper oxide films. In this state, plasma processing is started.

The plasma processing in this embodiment is separated into a preprocessing step and a main processing step. In both of the preprocessing step and the main processing step, a high-frequency voltage is applied from the high-frequency power source 16 via the matching circuit to the antenna 14, thereby a high-frequency electric field being applied to the discharge tube 13. The first gas source 17A supplies Ar gas from an upper end of the discharge tube 13 to the reaction space 12. With application of high voltage to an igniter (not shown), a primary plasma 26 is ejected from the lower end of the discharge tube 13 into the chamber of the mixer 21. The primary plasma 26 is a plasma resulting from plasmanization of Ar gas and is an inductively coupled plasma of high plasma density and high temperature (thermal plasma).

In the preprocessing step, Ar/O₂ gas is supplied from the third gas source 17C via the gas supply ports 23 to the mixing chamber 22. The primary plasma 26 (Ar plasma) derived from the discharge tube 13 is introduced to an Ar/O₂ gas region in the mixing chamber 22, causing the Ar gas in the mixed gas to be excited, so that a secondary plasma 27 (Ar plasma) is generated. The secondary plasma 27 is developed over the whole region of the mixing chamber 22 and is ejected downward from the plasma ejection port 22a to be irradiated to the object 2. Then, the secondary plasma 27 activates oxygen, and the activated oxygen causes chemical reaction with organic matters on copper oxide of the surface of the object 2, thereby the organic matters being decomposed and removed.

Subsequent to the preprocessing step, the main processing step is executed. In the main processing step, the mixed gas supplied to the mixing chamber 22 is switched from Ar/O₂ gas from the third gas source 17C to Ar/H₂ gas from the second gas source 17B. The primary plasma 26 ejected from the discharge tube 13 excites Ar gas in the mixed gas introduced to an Ar/H₂ gas region in the mixing chamber 22, thereby the secondary plasma 27 being generated. The secondary plasma 27 is developed over the whole region of the mixing chamber 22 and ejected downward from the plasma ejection port 22a so as be irradiated to the object 2. The secondary plasma 27 activates H₂ and the activated H₂ causes the chemical reactions indicated by the following expressions (1) and (2) on the surface of the object 2, thereby the copper oxide films being reduced and removed.

CuO+H₂→Cu+H₂O (1)

Cu₂O+H₂→2Cu+H₂O (2)

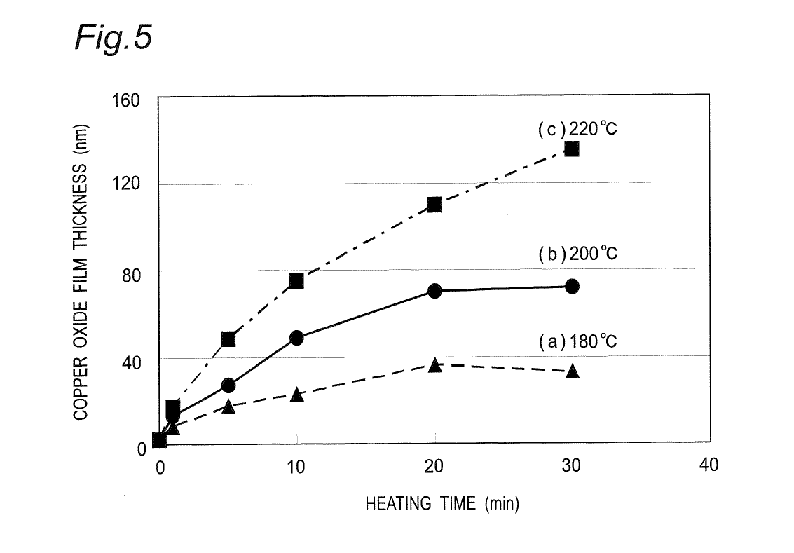

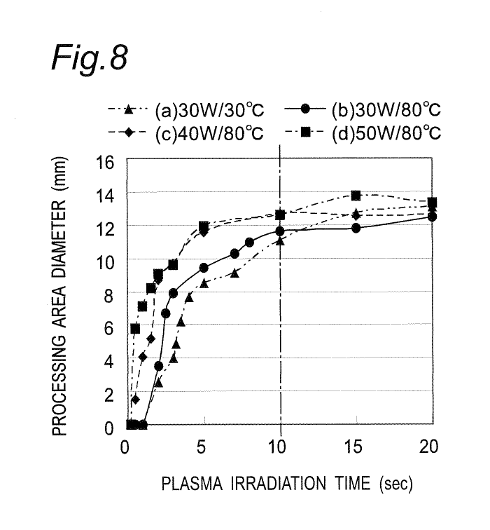

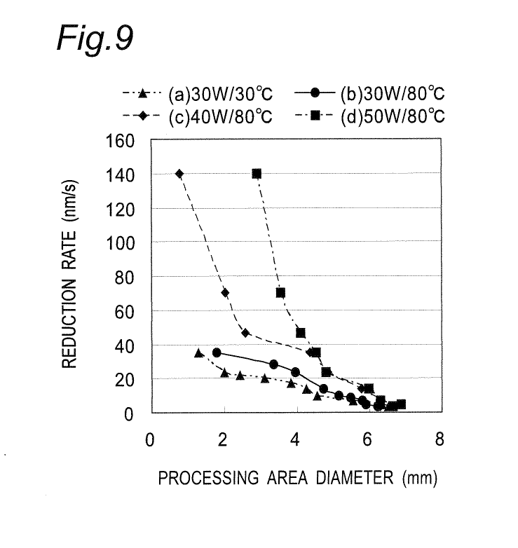

As will be described later with reference to FIG. 5, a film thickness of a copper oxide film formed by heating of copper can be determined from heating temperature and heating time. Meanwhile, as will be described later with reference to FIGS. 8 and 9, reduction rate can also be previously measured. From these relationships, a necessary plasma exposure time in the main processing step can be estimated.

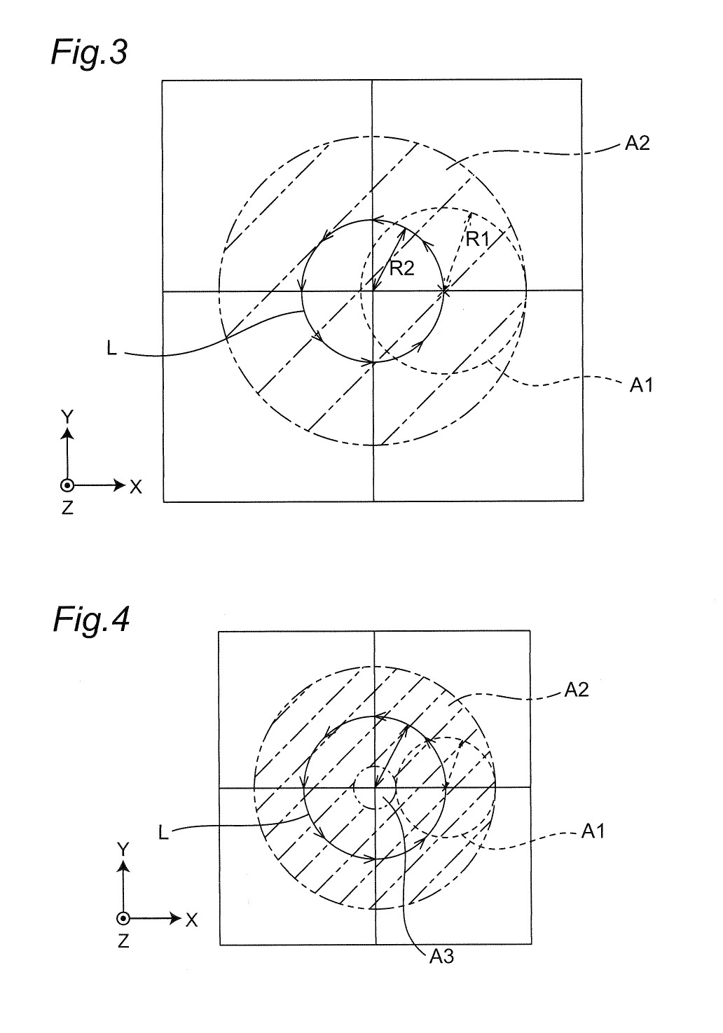

The main processing step will be explained in more detail below. In the main processing step, the plasma head 11 (plasma ejection port 22a) is moved horizontally by the moving unit 5 so that an irradiation area A1 (indicated by dotted line) of the secondary plasma 27 for the object 2 is moved as shown in FIG. 3. More specifically, as shown in FIG. 3, the irradiation area A1 moves on a circular locus L (indicated by solid line) at a constant speed to turn thereon a plurality of times. As a result, as indicated by two-dot chain line in FIG. 3, an area (processing area A2) in which the copper oxide film layer on the object 2 has been reduced and removed is formed into a circular shape larger in area than the irradiation area A1. Thus, the movement of the irradiation area A1 of the secondary plasma 27 in the object 2 can suppress temperature increases of the object 2 due to heat of reaction of the secondary plasma 27, as well as resultant oxidation reaction (re-oxidation) of copper, so that processing uniformity can be ensured even in case that the area region subject to reduction and removal of copper oxide films is large. Consequently, partial reduction and removal of copper oxide films can be achieved efficiently.

Especially, in this embodiment, since the irradiation area A1 of the secondary plasma 27 is moved at a constant speed, the reduction and removal of copper oxide films can be achieved more uniformly in the processing area A2 obtained by the movement of the irradiation area A1.

The locus L on which the irradiation area A1 is moved is not limited to such circular shape as shown in FIG. 3 but may be set to various shapes (circular-arc shapes) such as elliptical, polygonal or other various endless shapes, circular-arc shapes, helical shapes, quadric curve shapes, and polygonal line shapes, depending on the shape and area of the processing area A2. Although depending on the shape of the processing area A2, the locus L on which the irradiation area A1 moves is preferably set so as to include overlaps between moving irradiation areas A1. For example, on condition that the irradiation area A1 is formed into a circular shape having a radius R1 while the necessary processing area A2 is the entire region enclosed by a circle defined by two-dot chain line as shown in FIG. 3, the radius R2 of the circular shape of the locus L needs to be set smaller than the radius R1. In this case, if the radius R2 of the locus L restricting movement of the center of the irradiation area A1 were larger than the radius R1 of the irradiation area A1, a circular area A3 out of the target of reduction and removal of the copper oxide film would be left in neighborhood of the center of the processing area A2 as shown in FIG. 4.

Since the irradiation area A1 of the secondary plasma 27 is moved and moreover the temperature of the copper oxide film is set high by heating of the object 2 by the heating unit 7, chemical reaction with hydrogen activated by the secondary plasma 27 is accelerated, so that the copper oxide film can be reduced and removed more efficiently.

Further, since the main processing step is executed after organic matters on the copper oxide film of the object 2 are previously decomposed and removed by the preprocessing step, the reduction and removal of the copper oxide film with H₂ activated by the secondary plasma 27 can be achieved more efficiently.

Further, the mask 24 (see FIG. 2) is placed between the atmospheric plasma irradiation unit 4 and the object 2, and only portions of the surface of the object 2 that are targeted for reduction and removal of the copper oxide film are exposed to the secondary plasma 27. Therefore, irradiating the secondary plasma 27 of atmospheric plasma to the copper oxide film can be prevented, so that the reduction and removal of the copper oxide film of intended portions can be achieved more efficiently.

As conceptually shown in FIG. 2, a mixed gas area 28 for the mixed gas of Ar gas and hydrogen gas is formed at an outer periphery of the secondary plasma 27 in the mixing chamber 22. The mixed gas area 28 is lower in degree of plasmanization than that in neighborhood of the primary plasma 26 located closer to the center of the mixing chamber 22. This mixed gas area 28 for the mixed gas of Ar gas and hydrogen gas can prevent oxygen in the air from entering into the secondary plasma 27. This can also efficiently prevent the re-oxidation of copper during the reduction and removal of the copper oxide.

Further, during the above-described preprocessing step, the irradiation area A1 of the secondary plasma 27 to the object 2 may be moved in a circular or other-shaped locus, as it is during the main processing step.

The present invention is not limited to the above-described embodiment and may be modified in various ways, for example, as listed below.

Either one of the inert gas supplied from the first gas source 17A, the inert gas in the mixed gas supplied from the second gas source 17B, and the inert gas in the mixed gas supplied from the third gas source 17C, may be replaced with an inert gas other than Ar gas (e.g., Ne gas, Xe gas, He gas, N₂ gas).

The movement of the irradiation area of the secondary plasma may be achieved by other than the movement of the atmospheric plasma irradiation unit 4. For example, the stage 3 may be moved while the atmospheric plasma irradiation unit 4 is immobilized or that both of the atmospheric plasma irradiation unit 4 and the stage 3 are moved. In short, it is merely required that the movement of the irradiation area of the secondary plasma is achieved by relative movement between the atmospheric plasma irradiation unit 4 and the stage 3.

The preprocessing step for removal of organic matters and the main processing step for reduction and removal of copper oxide films may be executed by different types of plasma heads. Further, these steps may be executed by different types of atmospheric plasma irradiation units.

Next, various experiments and discussions that have led the present inventor to conceive the present invention are explained below. It is noted that differences to the embodiment and specific numerical values and the like are as follows. The plasma head 11 (plasma ejection port 22a) is not moved. The preprocessing step is not executed. The object 2 is a copper plate having length and width of 20 mm each and a thickness of 0.1 mm. A ceramic discharge tube 13 having an outer diameter of 1.2 mm and an inner diameter of 0.8 mm is provided on a wavy-shaped, flat-plate type antenna 14 having an overall length of 9.8 mm. Various conditions including an inner diameter R3 of the plasma ejection port 22a, a lead-in length 61 (distance from lower face of the mixer 21 to lower end of the discharge tube 13) of the discharge tube 13, and the gap 62 (distance from lower face of the mixer 21 to object 2) as shown in FIG. 1 are as shown in the flowing table:

TABLE 1

| | | | | |
|---|---|---|---|---|
| Power of high- | 30-50 | W | Ar flow rate | 60 sccm |
| frequency power | | | (first gas source) | |
| source | | | | |
| Inner diameter of | 7 | mm | Ar/H₂ flow rate | 200 sccm |
| plasma ejection | | | (second gas source) | |
| nozzle: R3 | | | | |
| Lead-in length of | 5 | mm | H₂ Concentration | 0-4% |
| discharge tube: δ1 | | | (second gas source) | |
| Gap: δ2 | 3.5 | mm | Stage temperature | 30-80° C. |

With use of a scanning X-ray photoelectron spectroscopic analyzer (ESCA), quantitative measurement of film thickness of copper oxide films was performed. Its results are shown in FIG. 5, where the horizontal axis represents heating time and the vertical axis represents copper oxide film thickness. As the heating temperature of the stage 3 with the object 2 held thereon becomes higher, and as the heating time becomes longer, the copper oxide film on the surface of the object 2 grows more. For example, it can be seen that (b) the copper plate heated at 200° C. for 30 minutes had a copper oxide film of about 70 nm, whereas (c) a copper plate heated at 220° C. came to have a copper oxide film of about 70 nm in 10 minutes.

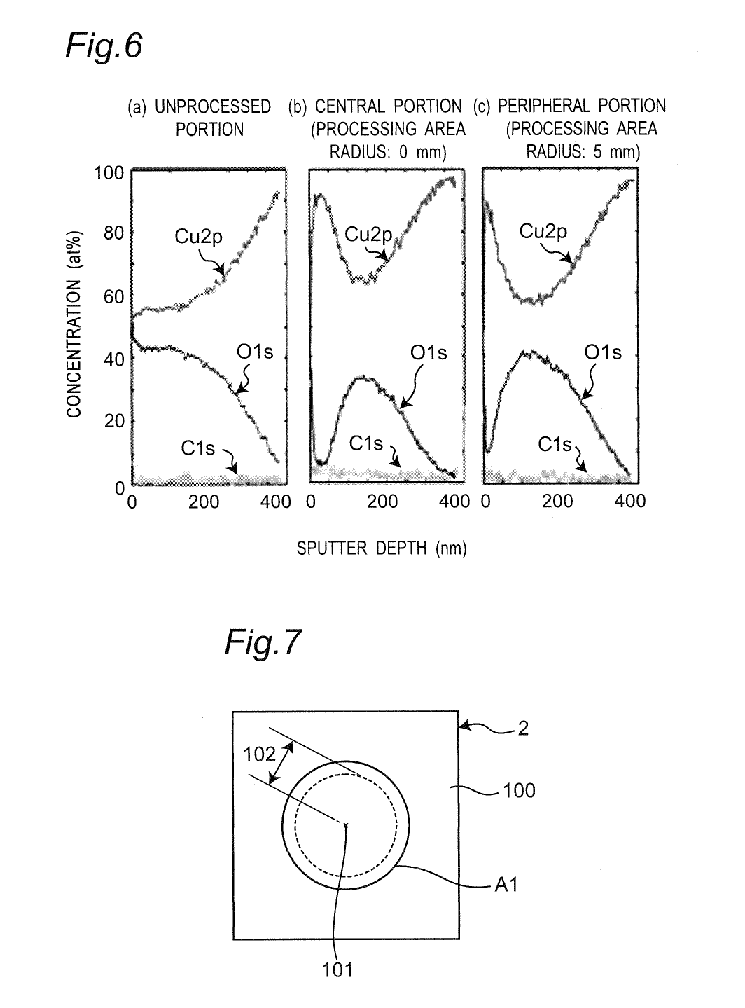

In order to observe variations on the plasma exposure surface, atomic concentration of the copper plate surface was measured with a scanning X-ray photoelectron spectroscopic analyzer (ESCA). In FIG. 6, the vertical axis represents atomic concentrations of copper by Cu2p, oxygen by O1s, and carbon by C1s. The horizontal axis represents sputter depth, where atomic concentrations of the surface of the object 2 were measured while the object 2 was sputtered with Ar by the analyzer. FIG. 6 shows results of plasma processing (main processing step) executed at a stage temperature of 80° C. for 5 sec. with a 30 W power of the high-frequency power source on a copper plate, which was the object 2 heated at 250° C. for 30 min. With further reference to FIG. 7, it can be seen that in an unprocessed portion 100 (a region outside the irradiation area A1), a copper oxide film grew up to near a 400 nm depth of the copper plate that is the object 2. In a central portion 101 (radius 0 mm) of the irradiation area A1, it can be seen that by plasma reduction, the copper oxide film returned to copper up to about 100 nm from the surface of the copper plate. Under the copper was the copper oxide film layer again, while unoxidized ground copper was seen at a depth of 400 nm. In a peripheral portion 102 (radius 5 mm), similarly, reduction was seen to an extent of about 50 nm from the surface of the copper plate, which was the object 2. With the copper plate that is the object 2 heated at 200° C. for 30 min., since the copper oxide film only had a thickness as small as 70 nm basically according to FIG. 5, an unoxidized copper surface was exposed even near the peripheral portion (radius 5 mm) even with plasma processing applied under the same condition; in a case where the plasma-processed copper plate of the object 2 was put into a solder dipping bath as an example, there was solder sticking to the plasma exposure surface in the peripheral portion. It can also be seen from FIG. 6 that there were large differences between the exposure surfaces of the central portion and the peripheral portion.

Reduction rate was evaluated by solder-wetted area resulting from changing the plasma exposure time. Since the film thickness of the copper oxide film on the copper plate heated at 200° C. for 30 min. is 70 nm constant according to FIG. 5, the reduction of up to the ground with solder sticking thereto means a processibility of as high as 70 nm even at the boundary portion with the exposure time.

FIG. 8 is a graph in which processing area diameter is plotted with the plasma exposure time set on the horizontal axis. Comparisons were made under the processing conditions: (a) a 30 W power of the high-frequency power source and a stage temperature of 30° C., (b) a 30 W power of the high-frequency power source and a stage temperature of 80° C., (c) a 40 W power of the high-frequency power source and a stage temperature of 80° C., and (d) a 50 W power of the high-frequency power source and a stage temperature of 80° C. The reason of a setting of the stage temperature to 80° C. is that, for heating of the stage 3, higher temperatures more accelerate the reduction process, whereas temperatures beyond 100° C. would cause thermal oxidation to progress to more extent unexpectedly because of its heat around the reduction process.

The four graphs (a)-(d) of FIG. 8 show differences in behavior between time zones of under 10 sec. and over 10 sec. In the time zone over 10 sec., the processing area of the object 2 is limited by a reach range of activated H₂ irrespective of the power of the high-frequency power source and the temperature of the stage 3. For this mixer, the reach range of activated hydrogen radicals is about 12 mm. Meanwhile, in the zone under 10 sec., there can be seen changes due to the power of the high-frequency power source and the stage temperature of the stage 3. In a comparison between (a) the case of the stage temperature of 30° C. and (b) the case of the stage temperature of 80° C., it can be seen that the processing area is enlarged by the heating to the stage temperature of 80° C. even with the same processing time. In comparisons among (b) 30 W power of the high-frequency power source, (c) 40 W power of the high-frequency power source, and (d) 50 W power of the high-frequency power source, it can be seen that as the power of the high-frequency power source becomes higher, the processing area of the object 2 becomes larger and larger under the condition of equal time durations.

FIG. 9 is a modification of the graph of FIG. 8 where the horizontal axis indicates the processing area radius of the object 2 the horizontal axis and the vertical axis indicates the reduction rate. From the graphs of FIGS. 9(a) and (b), effects of the heating of the stage 3 can be observed. It can be seen that (b) the reduction rate at 30W/80° C. is more than 20 nm/sec. within the 4 mm radius of the processing area. This result well coincides with the result of the graphs of FIG. 6 described before. Also, from comparisons among FIGS. 9(b), (c) and (d), it can be seen that the reduction rate increases higher with increasing power of the high-frequency power source, so that a removal of copper oxide film was able to be fulfilled at a high rate as much as 140 nm/sec. within a 3 mm radius range under the condition of (d) 50 W.

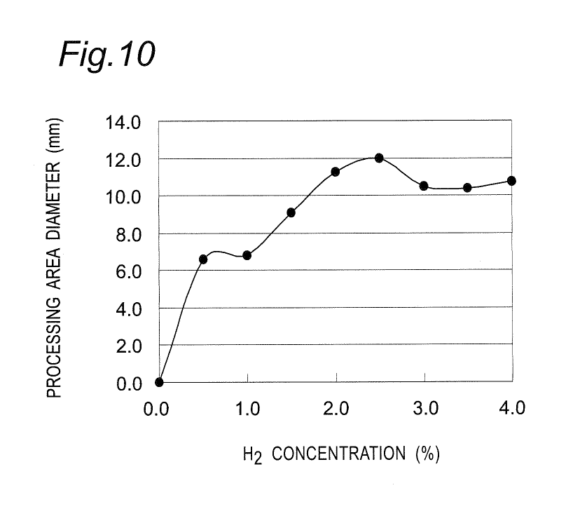

On the surface of the copper plate of the object 2, there occur reactions (formulae (1), (2) described above) by H₂ activated by Ar plasma, and the copper oxide film of the surface of the object 2 is reduced to return to copper. Smaller mixing amounts of H₂ involve smaller numbers of atoms causing chemical reactions, while larger addition amounts of H₂ cause lowering of the strength of Ar plasma, suggesting that there is an optimum value for hydrogen concentration in Ar/H₂. A copper plate of the object 2 oxidized at 200° C. was subjected to plasma exposure for 20 sec. with the H₂ concentration changed to 0 to 4% under the conditions of 30 W power of the high-frequency power source and 80° C. stage temperature, and thereafter dipped in a solder dipping bath for 5 sec., followed by measuring regions to which solder stuck. In FIG. 10, the horizontal axis represents H₂ concentration and the vertical axis represents the processing area radius of the object 2. The largest processing area resulted under a H₂ concentration of 2.5%. This result was unchanged even with changes in the power of the high-frequency power source, the stage temperature and the plasma exposure time.

It is to be noted that, combinations of any of various embodiments described above can exhibit their respective effects.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The entire disclosure of Japanese Patent Application No. 2010-251959 filed on Nov. 10, 2010, including specification, drawings, and claims are incorporated herein by reference in its entirety.

1-9. (canceled)

10. A plasma processing apparatus comprising:
a holding section for holding an object subject to removal of a copper oxide film;
an atmospheric plasma irradiation unit including, an inductively coupled plasma generation section for ejecting a primary plasma formed of an inductively coupled plasma of a first inert gas, and a plasma development section for generating a secondary plasma formed of a mixed gas plasmanized by collisions of the primary plasma with a mixed gas region of a second inert gas and a reactive gas, the atmospheric plasma irradiation unit irradiating the secondary plasma to the object; and
a moving section for relatively moving the holding section and the atmospheric plasma irradiation unit so that an irradiation area of the secondary plasma to the object is moved
wherein the first and second inert gases are Ar gas and the reactive gas is H₂ gas, and
wherein an H₂ concentration of the mixed gas including the Ar gas, which is the second inert gas, and the H₂ gas, which is the reactive gas, is not less than 0.5% and not more than 3.0%.

11. The plasma processing apparatus according to claim 10, wherein the H₂ concentration of the mixed gas is 2.5%.

12. The plasma processing apparatus according to claim 10, wherein the moving section relatively moves the holding section and the atmospheric plasma irradiation unit so that the irradiation area is moved at a constant speed.

13. The plasma processing apparatus according to claim 10, wherein the moving section relatively moves the holding section and the atmospheric plasma irradiation unit so that the irradiation area is moved in a circular or circular-arc shape.

14. The plasma processing apparatus according to claim 10, wherein the moving section relatively moves the holding section and the atmospheric plasma irradiation unit so that there arises an overlap between the moved irradiation areas.

15. The plasma processing apparatus according to claim 10, wherein the holding section includes a heating unit for heating the object.

16. The plasma processing apparatus according to claim 10,
wherein the plasma development section, being enabled to switch the mixed gas in the mixed gas region between a first mixed gas, which is a mixed gas of Ar gas and H₂ gas, and a second mixed gas, which is a mixed gas of Ar gas and O₂ gas,
wherein the plasma development section generates the secondary plasma by plasmanizing the second mixed gas with the primary plasma derived from the inductively coupled plasma generation section to irradiate the secondary plasma to the object, and then generates the secondary plasma by plasmanizing the first mixed gas with the primary plasma derived from the inductively coupled plasma generation section to irradiate the secondary plasma to the object.

17. The plasma processing apparatus according to claim 10, wherein placed between the atmospheric plasma irradiation unit and the object is a mask for allowing only portions of a surface of the object subject to reduction and removal of copper oxide films to be exposed to the secondary plasma.

18. A plasma processing method comprising:
generating a primary plasma formed of an inductively coupled plasma of a first inert gas followed by generation of a secondary plasma formed of a plasmanized mixed gas resulting from collision of the primary plasma to the mixed gas of a second inert gas and the reactive gas; and
while moving the secondary plasma relative to the irradiation area, irradiating the secondary plasma to a copper oxide film of the surface of the object,
wherein the first and second inert gases are Ar gas and the reactive gas is H₂ gas, and
wherein an H₂ concentration of the mixed gas including the Ar gas, which is the second inert gas, and the H₂ gas, which is the reactive gas, is not less than 0.5% and not more than 3.0%.
